(19) United States
(12) Patent Application Publication
(10) Pub. No.: US 2015/0237360 A1
(43) Pub. Date: Aug. 20, 2015

(54) APPARATUS AND METHOD FOR FAST SAMPLE ADAPTIVE OFFSET FILTERING BASED ON CONVOLUTION METHOD

(71) Applicant: Electronics and Telecommunications Research Institute, Daejeon (KR)

(72) Inventors: Hyun-Mi KIM, Daejeon (KR); Kyung-Jin BYUN, Daejeon (KR); Nak-Woong EUM, Daejeon (KR)

(21) Appl. No.: 14/623,235

(22) Filed: Feb. 16, 2015

(30) Foreign Application Priority Data
Feb. 18, 2014 (KR) 10-2014-0018558

(51) Int. Cl. H04N 19/44; H04N 19/182; H04N 19/132; H04N 19/117; H04N 19/119

(52) U.S. Cl. CPC H04N 19/44; H04N 19/117; H04N 19/119; H04N 19/132; H04N 19/182

(57) ABSTRACT

Disclosed herein is an apparatus for fast Sample Adaptive Offset filtering based on a convolution method, for decoding of a video. According an embodiment, the apparatus may include: an input stream provider for sequentially providing a window buffer with pixels read from a buffer that stores input data related to an SAO filter; a window buffer for defining the provided pixels as one or more windows, and for delivering the pixels on a defined window basis to one or more calculation logics; and one or more calculation logics for calculating an offset for the pixels input on the window basis, and for outputting a corrected pixel by adding the calculated offset to a target pixel.

### CROSS REFERENCE TO RELATED APPLICATION(S)

This application claims the benefit of Korean Patent Application No. 10-2014-0018558 filed Feb. 18, 2014, which is hereby incorporated by reference in its entirety into this application.

### BACKGROUND OF THE INVENTION

1. Technical Field

The present invention generally relates to an apparatus and method for fast Sample Adaptive Offset filtering based on a convolution method and, more particularly, to improving the operation speed of Sample Adaptive Offset filter that is used for decoding of a compressed video signal, and optimizing hardware area.

2. Description of the Related Art

High Efficiency Video Coding (HEVC), standardized by Joint Collaborative Team on Video Coding (JCT-VC) which was jointly organized by ITU-T SG 16 WP 3 and ISO/IEC JTC 1/SC 29/WG 11 has improved coding efficiency that is about twice higher than that of existing coding methods. Newly added tools including Quad-tree Coding unit, asymmetric motion partition, merge mode, and the like significantly contribute to coding efficiency. Sample Adaptive Offset (SAO), one of the tools newly added to HEVC, contributes to improvement of subjective and objective image quality by being applied after deblocking filtering in a decoding process. Korean Patent Application Publication No. 10-2013-0034614 discloses method and apparatus for video encoding and decoding based on constrained offset compensation and loop filter.

### SUMMARY OF THE INVENTION

Disclosed is an apparatus and method for Sample Adaptive Offset filtering that is used to implement a fast Sample Adaptive Offset filter and optimize hardware area when designing a HEVC decoder.

According to an embodiment, an apparatus for Sample Adaptive Offset filtering may include: an input stream provider for sequentially providing a window buffer with pixels read from a buffer that stores input data related to an SAO filter; a window buffer for defining the provided pixels as one or more windows, and for delivering the pixels on a defined window basis to one or more calculation logics; and one or more calculation logics for calculating an offset for the pixels input on the window basis, and for outputting a corrected pixel by adding the calculated offset to a target pixel.

In this case, the window buffer includes one or more registers and a block RAM, wherein at least some of the one or more registers and the block RAM may be connected with each other.

In this case, the number of the one or more registers may be determined based on a number of pixels to be parallel-processed and a kernel size.

In this case, the calculation logic may include: a first calculation unit for calculating, using pixels included in each of the windows, a value of a sample index for calculation of an edge offset; a second calculation unit for calculating an edge offset and a band offset, based on the value of the sample index, which is calculated by the first calculation unit; and a third calculation unit for selecting any one of the edge offset and the band offset using an SAO type index, and for outputting the corrected pixel by adding the selected offset to the target pixel.

The first calculation unit may perform multiplexing of pixels around a target pixel in each window according to an edge type, and calculates a result of multiplexing and a value of the target pixel as the value of the sample index.

The second calculation unit may decide, using the calculated value of the sample index, a category for an edge offset, and calculate the edge offset based on the category.

The second calculation unit may calculate a band offset based on a value of a predetermined bit of the sample index value that is calculated based on the value of the target pixel.

According to an embodiment, a method for Sample Adaptive Offset filtering may include: sequentially providing pixels read from a buffer that stores input data related to SAO filter; delivering the provided pixels to one or more calculation logics by one or more windows; calculating an offset for the pixels that are input on the window basis; and outputting a corrected pixel by adding the calculated offset to a target pixel.

In this case, the window buffer includes one or more registers and a block RAM, wherein at least some of the one or more registers and the block RAM may be connected with each other.

In this case, the number of the one or more registers may be determined based on a number of pixels to be parallel-processed and a kernel size.

Calculating the offset may include: calculating, using pixels included in each of the windows, a value of a sample index for calculation of an edge offset; calculating an edge offset and a band offset, based on the calculated value of the sample index; and selecting, using an SAO type index, any one of the edge offset and the band offset.

Calculating the value of the sample index may include: performing multiplexing of pixels around a target pixel in each window according to an edge type; and calculating a result of multiplexing and a value of the target pixel as the value of the sample index.

Calculating the edge offset may include deciding, using the calculated value of the sample index, a category for an edge offset, the edge offset being calculated based on the decided category.

In calculating the band offset, the band offset may be calculated based on a value of a predetermined bit of the sample index value that is calculated based on the value of the target pixel.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram of a HEVC-based video decoding device in which a fast SAO filtering apparatus is applied, according to an embodiment of the present invention;

FIG. 2 illustrates an example of an edge offset class according to an edge direction;

FIG. 3 illustrates an example of a category of an edge offset;

FIG. 4 is a block diagram of a fast SAO filtering apparatus according to an embodiment of the present invention;

FIG. 5 is illustrates a configuration of a window buffer of the fast SAO filtering apparatus according to the embodiment of FIG. 4;

FIG. 6 illustrates an example of a window delivered from the window buffer of FIG. 5 to a calculation logic;

FIG. 7 illustrates a detailed configuration of a calculation logic of the fast SAO filtering apparatus according to the embodiment of FIG. 4;

FIG. 8 is a flow diagram of a method for fast SAO filtering according to an embodiment of the present invention; and

FIG. 9 is a detailed flow diagram of an offset calculation step of the embodiment of FIG. 8.

### DESCRIPTION OF THE PREFERRED EMBODIMENTS

Detailed matters of embodiments are contained in the detailed description and drawings. Advantages and features of the present invention and methods of accomplishing the same may be apparent from the following description of the embodiments of the present invention in conjunction with the accompanying drawings. The same reference numerals designate the same part in the present invention.

Hereinafter, embodiments of an apparatus and method for fast SAO filtering based on a convolution method will be described in detail referring to the drawings.

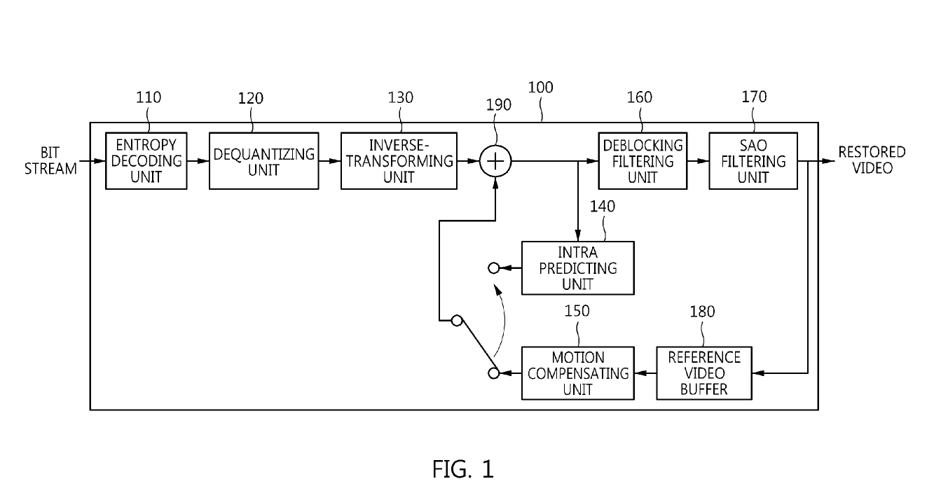

FIG. 1 is a block diagram of a HEVC-based video decoding device in which a fast SAO filtering apparatus is applied, according to an embodiment of the present invention.

Referring to FIG. 1, a HEVC-based video decoding device 100 may include an entropy decoding unit 110, a dequantizing unit 120, an inverse-transforming unit 130, an intra predicting unit 140, a motion compensating unit 150, a deblocking filtering unit 160, an SAO filtering unit 170, a reference video buffer 180, and an adder 190.

The video decoding device 100 may receive a bit stream, output from an encoder, as an input, and may output a restored video, which is reconstructed by decoding the bit stream in intra-mode or inter-mode. In case of the intra-mode, prediction is performed in the intra predicting unit 140. On the other hand, in case of the inter-mode, prediction may be performed in the motion compensating unit 150.

After obtaining a residual block restored from the input bit stream, and generating a prediction block, the video decoding device 100 may generate a restored block, which is reconstructed by adding the residual block and the prediction block.

The entropy decoding unit 110 may generate quantized coefficient types of symbols by performing entropy-decoding on the input bit stream according to probability distribution. The entropy decoding method may be performed in response to an entropy encoding method. In this case, the quantized coefficient is dequantized in the dequantizing unit 120, and is inverse-transformed in the inverse-transforming unit 130. As a result of dequantization/inverse-transformation of the quantized coefficient, a residual block may be generated.

In case of the intra-mode, the intra predicting unit 140 may generate a prediction block by performing spatial prediction using pixel values of an already encoded block around a current block. In case of the inter-mode, the motion compensating unit 150 may generate a prediction block by performing motion compensation using a motion vector and a reference video stored in the reference video buffer 180.

The adder 190 may generate a restored block based on the residual block and the prediction block.

The deblocking filtering unit 160 outputs a reconstructed video, that is, a restored video. In this case, in a general deblocking filtering process, filtering on the restored video is always performed regardless of an encoding parameter or whether to apply constrained intra prediction. Accordingly, an error caused during the filtering process may be spread to an area of the restored video, where an error has not occurred. For example, an error occurring in an inter-encoded block may be spread to an intra-encoded block. Therefore, the general deblocking filtering process may degrade subject image quality of the restored video.

Consequently, to solve the above mentioned problem of the deblocking filtering process, the SAO filtering unit 170, located in the next of the deblocking filtering unit 160, performs filtering on one frame of a video using a band offset filter or an edge offset filter. In contrast with the deblocking filter, as the SAO filter directly calculates an error between an original video and a restored video, it is possible to improve objective image quality as well as subjective image quality.

In this case, SAO generally receives an offset value for each Coding Tree Block (CTB) based on Quad-tree, and corrects an error of the decoded pixels using the offset value.

The following Table 1 represents SAO types, and each CTB is generally determined as one of the following three types of SAO.

TABLE 1

| SaoTypeIdx | SAO type |
|---|---|
| 0 | No Filter |
| 1 | Band Offset |
| 2 | Edge Offset |

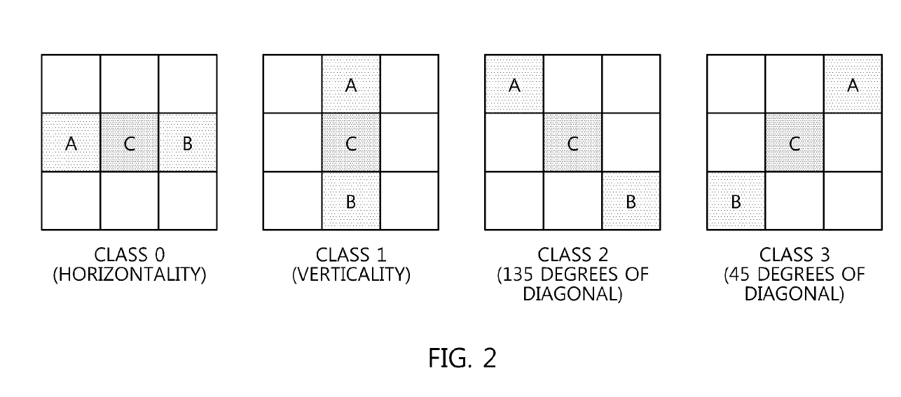

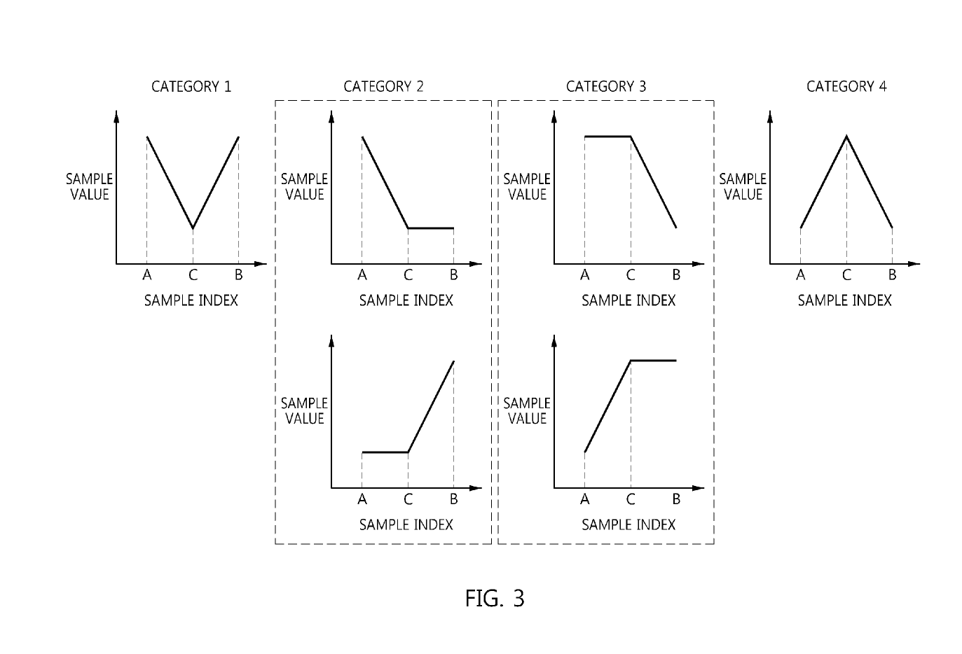

FIG. 2 illustrates an example of an edge offset class according to an edge direction, in other words, an example of an edge type. FIG. 3 illustrates an example of a category of an edge offset.

As shown in FIG. 2, the edge offset among the SAO types of Table 1 may be categorized into four edge types according to an edge direction. In this case, pixel c located in the center of each edge type is a target pixel to be corrected. Pixels a and b are peripheral pixels, which are determined by the edge direction. Also, according to the determined SAO type and edge type, pixels in CTB may be categorized into four categories shown in FIG. 3 by a predetermined rule. For these pixels that have been categorized into each of the categories, an error may be corrected by adding anyone among four offset values that are delivered from header information for each category.

In case of a band offset, when a pixel value is included in a specified pixel area among pixel areas that are categorized into 32 areas, the offset is applied. Consequently, a band offset is pixel-based filtering, and the band offset depends on nothing but the delivered header information and corresponding pixel value.

However, in case of the edge offset, as four edge directional patterns are used for categorizing a sample as illustrated in FIG. 2, the edge offset may depend on eight pixels around a current pixel.

Hereinafter, embodiments of an apparatus and method for SAO filtering that performs fast filtering by applying a convolution method to the SAO filtering process will be described in detail.

According to embodiments of the present invention, a process for applying edge directional patterns is performed similar to convolution in video processing. In other words, a process of convolution by a sliding-window approach that uses a predetermined size of a window is applied to an edge offset filtering, whereby fast SAO filtering may be performed in a video decoding device and hardware area may be optimized.

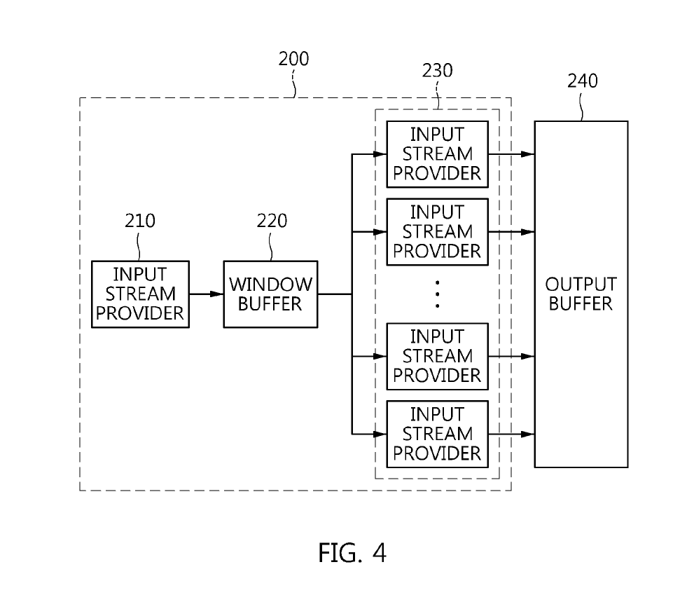

FIG. 4 is a block diagram of an SAO filtering apparatus according to an embodiment of the present invention.

The SAO filtering apparatus 200 described in FIG. 4 may be an embodiment of the SAO filtering unit 170 applied in the video decoding device 100 of FIG. 1.

Referring to FIG. 4, an SAO filtering apparatus 200 may include an input stream provider 210, a window buffer 220, and one or more calculation logics 230.

The input stream provider 210 may sequentially provide the window buffer 220 with pixels read from a buffer that stores input data related to an SAO filter. In this case, the input data related to the SAO filter may include information about a restored video that has been restored by filtering of the deblocking filtering unit 160 in the video decoding device 100 as illustrated in FIG. 1.

The window buffer 220 defines pixels, provided from the input stream provider 210, as one or more windows, and may deliver pixels on a window basis to one or more calculation logics.

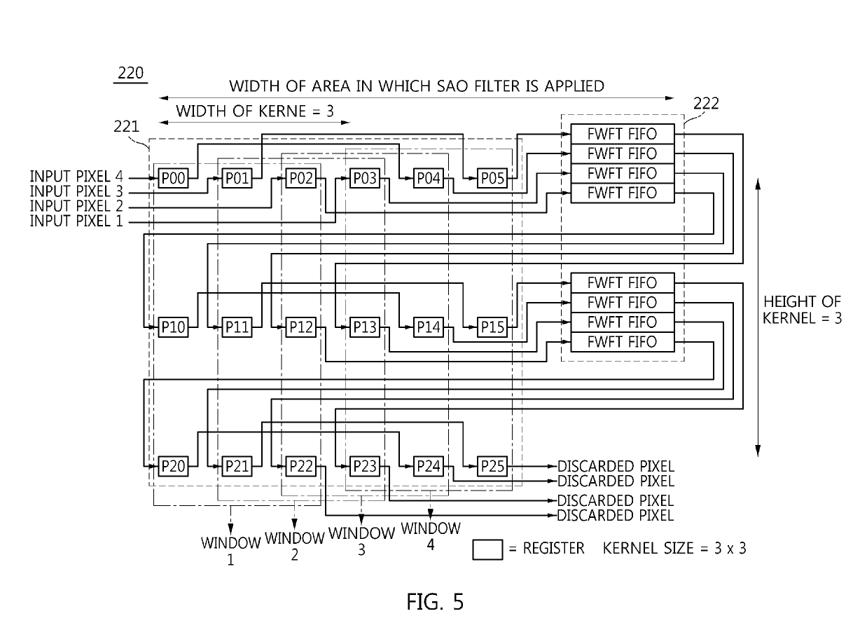

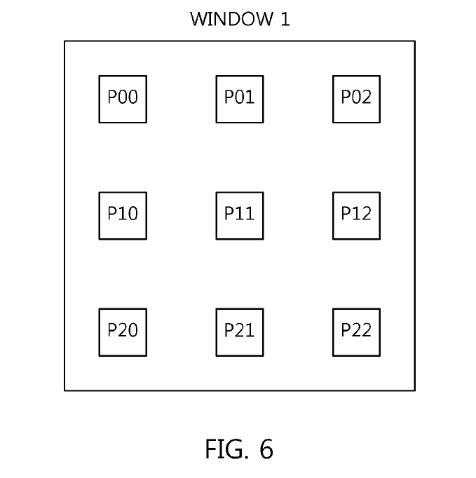

FIG. 5 illustrates a configuration of a window buffer of the fast SAO filtering apparatus according to the embodiment of FIG. 4. FIG. 6 illustrates an example of a window delivered from a window buffer of FIG. 5 to a calculation logic.

Referring to FIG. 5, the window buffer 220 may be configured to include one or more registers 221 and a block RAM 222. At least some of the registers 221 may be connected with the block RAM 222. Accordingly, access time of the window buffer 220 and hardware resources may be minimized. In this case, the block RAM 222 may be operated in First-In First-Out (FIFO).

Generally, to design a high-speed decoder, a pipeline approach may be adopted. Also, to improve the speed of SAO filtering, parallel processing may be performed in the SAO pipeline. According to a target speed of the decoder, the number of pixels to be parallel-processed is determined. If the number of the parallel-processed pixels is increased, processing time is decreased but the required hardware size is larger. Accordingly, the number of pixels to be parallel-processed is determined considering both processing time and the hardware size.

Consequently, the size of the window buffer is determined according to the speed of parallel-processing and the hardware size. In other words, a register 221 included in the window buffer may fast access data but requires a large hardware area compared to RAM. Therefore, the size of the window buffer 220 may be determined by determining the proper number of registers using the following Equation (1):

the number of registers=(the number of pixels to be parallel−processed+(kernel size−1))×kernel size (1)

For example, as illustrated in FIG. 5, when the kernel size is 3 and the number of pixels to be parallel-processed is 4, the number of registers becomes 18.

In this case, as illustrated in FIGS. 5 and 6, the window buffer 200 delivers pixels stored in the register 221 to the calculation logic 230 on a window basis. For example, as illustrated, four windows, those are, window 1, 2, 3, and 4 may be defined for a kernel of which the size is three-by-three, and each of the windows is delivered to a corresponding calculation logic 230 to be processed.

In this case, to the calculation logic 230, the window buffer 220 may deliver a window in which the x, y coordinates of a general image are reversed.

Each of the calculation logics 230 receives both respective pixels delivered on a window basis, and the SAO type index (SaoTypeIdx) and edge type, delivered from header, as inputs. Then, each of the calculation logics 230 calculates an offset according to the inputs, and may output a corrected pixel by adding the calculated offset to the target pixel.

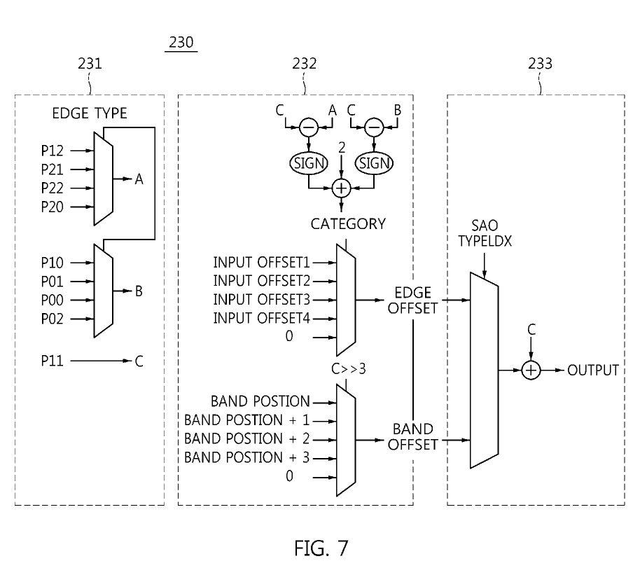

FIG. 7 illustrates a detailed configuration of a calculation logic of the fast SAO filtering apparatus according to the embodiment of FIG. 4.

Referring to FIG. 7, each of the calculation logics 230 will be described in detail. As illustrated, each of the calculation logics 230 may include a first calculation unit 231, a second calculation unit 232, and a third calculation unit 233.

The first calculation unit 231 performs a first calculation process for calculating an offset. Among pixels included in a window, the first calculation unit 231 performs multiplexing of pixels around a target pixel, according to an edge type. Then, the result of multiplexing and a value of the target pixel are calculated as a sample index value.

For example, referring to FIGS. 2, 6, and 7, if an input edge type is a vertical direction of class 1 in FIG. 2, a value of a sample index c for a target pixel corresponds to a value of p11 among pixels included in a window of FIG. 6. Accordingly, by multiplexing of pixels around the target pixel p11, in other words, by multiplexing of p12, p21, p22, and p20, the value of p21 that is a pixel in the vertical direction is determined as a value of the sample index a. Also, by multiplexing of pixels around the target pixel p11, those pixels being p10, p01, p00, and p02, the value of the pixel p01 that is another pixel in the vertical direction may be determined as a value of the sample index b.

When the sample index values are calculated through multiplexing by the first calculation unit 231, the second calculation unit 232 may calculate an edge offset and band offset, based on the calculated values of the sample indexes.

For example, using the values of the sample indexes a, b, and c, which are calculated by the first calculation unit 231, one category is selected among categories illustrated in FIG. 3, and an edge offset may be calculated based on the selected category.

In this case, the second calculation unit 232 may calculate a band offset based on predetermined bits of the target pixel c, for example, based on five most significant bits of the target pixel.

Based on the input SAO type index (SaoTypeIdx), the third calculation unit 233 may select either the calculated edge offset or the calculated band offset. Also, the third calculation unit 233 may output a corrected pixel by adding the selected offset to a target pixel.

According to the present embodiment, a multiplexer (MUX) of each of calculation logics 230 may be previously set to minimize hardware resources, the multiplexer performing categorization for the band offset or categorization according to the four edge direction.

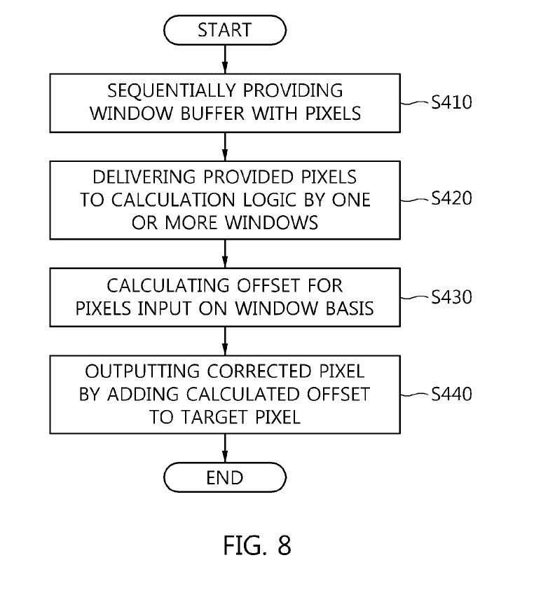

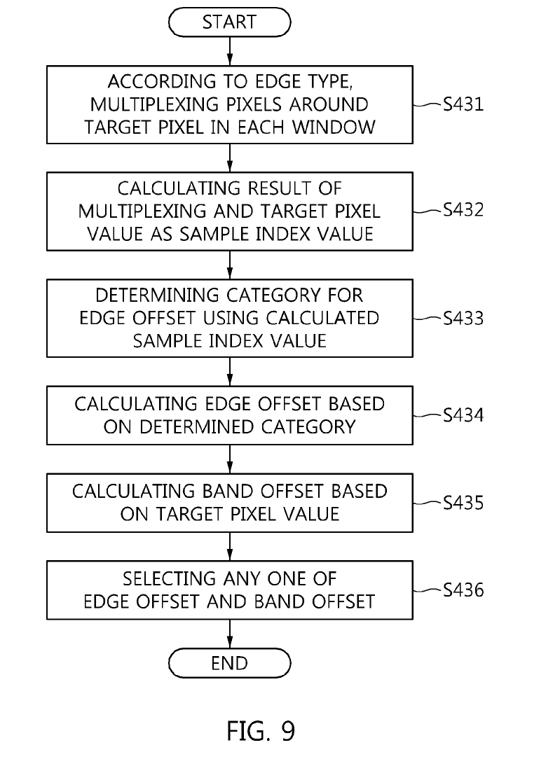

FIG. 8 is a flow diagram of a method for fast SAO filtering according to an embodiment of the present invention. FIG. 9 is a detailed flow diagram of an offset calculation step of the embodiment of FIG. 8.

FIGS. 8 and 9 may be an embodiment of a method for SAO filtering that is performed by an SAO filtering apparatus 200 according to the embodiment of FIG. 4.

Referring to FIG. 8, the SAO filtering apparatus 200 may sequentially provide a window buffer with pixels read from a buffer that stores input data related to an SAO filter at step S410.

Subsequently, the SAO filtering apparatus defines the pixels stored in the window buffer as one or more windows, and may deliver the pixels on a defined window basis to one or more calculation logics at step S420. In this case, considering the speed of parallel processing and the hardware size, the window buffer is configured to include one or more registers and a block RAM. To minimize hardware resource requirements, the registers and the block RAM may be used in connection with each other.

Then, using the pixels in a window, which are input from the window buffer, an offset may be calculated at step S430.

Concretely describing the step of calculating an offset, S430, referring to FIG. 9, first, multiplexing of pixels that are input on a window basis is performed according to an edge type at step S431. As described above, if one edge type is selected among the four edge types illustrated in FIG. 2, pixels corresponding to the selected edge type are selected.

Subsequently, the result of multiplexing and a target pixel value are calculated as sample index values. For example, the values of a, b, and c illustrated in FIG. 2, may be calculated at step S432.

Subsequently, using the calculated values of the sample indexes, a category for an edge offset may be determined at step S433. In this case, according to the values of the sample indexes, one category among four categories illustrated in FIG. 3 may be selected.

Subsequently, based on the selected category, an edge offset may be calculated at step S434.

Subsequently, based on the target pixel value, a band offset may be calculated at step S435. For example, based on five most significant bits of the target pixel value, the band offset may be calculated.

Subsequently, using the input SAO type index (SaoTypeIdx), either the calculated edge offset or the calculated band offset is selected at step S436.

Again referring to FIG. 8, a pixel corrected by adding the calculated offset to the target pixel may be output at step S440, the calculated offset being any one of the edge offset and the band offset.

A Sample Adaptive Offset filter, one of in-loop filters of HEVC, may be implemented to be quickly operated. Also, by optimizing hardware area, it is possible to implement a Sample Adaptive Offset filter effective in a hardware decoder as well as a software decoder.

Although the embodiments of the present invention have been disclosed for illustrative purposes, those skilled in the art will appreciate that various modifications, additions and substitutions are possible, without departing from the scope and spirit of the invention as disclosed in the accompanying claims. The embodiments described above are merely intended to describe the present invention and are not intended to limit the meanings thereof or the scope of the present invention described in the accompanying claims.

What is claimed is:

1. An apparatus for Sample Adaptive Offset filtering, comprising:
an input stream provider for sequentially providing a window buffer with pixels read from a buffer that stores input data related to an SAO filter;
a window buffer for defining the provided pixels as one or more windows, and for delivering the pixels on a defined window basis to one or more calculation logics; and
one or more calculation logics for calculating an offset for the pixels input on the window basis, and for outputting a corrected pixel by adding the calculated offset to a target pixel.

2. The apparatus of claim 1, wherein the window buffer includes one or more registers and a block RAM, and at least some of the one or more registers and the block RAM are connected with each other.

3. The apparatus of claim 2, wherein a number of the one or more registers is determined based on a number of pixels to be parallel-processed and a kernel size.

4. The apparatus of claim 1, wherein the calculation logic comprises:
a first calculation unit for calculating, using pixels included in each of the windows, a value of a sample index for calculation of an edge offset;
a second calculation unit for calculating an edge offset and a band offset, based on the value of the sample index, which is calculated by the first calculation unit; and
a third calculation unit for selecting any one of the edge offset and the band offset using an SAO type index, and for outputting the corrected pixel by adding the selected offset to the target pixel.

5. The apparatus of claim 4, wherein the first calculation unit performs multiplexing of pixels around a target pixel in each window according to an edge type, and calculates a result of multiplexing and a value of the target pixel as the value of the sample index.

6. The apparatus of claim 5, wherein the second calculation unit decides, using the calculated value of the sample index, a category for an edge offset, and calculates the edge offset based on the category.

7. The apparatus of claim 5, wherein the second calculation unit calculates a band offset based on a value of a predetermined bit of the sample index value that is calculated based on the value of the target pixel.

8. A method for Sample Adaptive Offset filtering, comprising:
sequentially providing pixels read from a buffer that stores input data related to an SAO filter;
delivering the provided pixels to one or more calculation logics by one or more windows;
calculating an offset for the pixels that are input on the window basis; and
outputting a corrected pixel by adding the calculated offset to a target pixel.

9. The method of claim 8, wherein the window buffer includes one or more registers and a block RAM, and at least some of the one or more registers and the block RAM are connected with each other.

10. The method of claim 9, wherein a number of the one or more registers is determined based on a number of pixels to be parallel-processed and a kernel size.

11. The method of claim 8, wherein calculating the offset comprises:
calculating, using pixels included in each of the windows, a value of a sample index for calculation of an edge offset;
calculating an edge offset and a band offset, based on the calculated value of the sample index; and
selecting, using an SAO type index, any one of the edge offset and the band offset.

12. The method of claim 11, wherein calculating the value of the sample index comprises:
performing multiplexing of pixels around a target pixel in each window according to an edge type; and
calculating a result of multiplexing and a value of the target pixel as the value of the sample index.

13. The method of claim 11, wherein calculating the edge offset comprises,
deciding, using the calculated value of the sample index, a category for an edge offset, the edge offset being calculated based on the decided category.

14. The method of claim 11, wherein in calculating the band offset, the band offset is calculated based on a value of a predetermined bit of the sample index value that is calculated based on the value of the target pixel.
